(19) United States
(12) Patent Application Publication
(10) Pub. No.: US 2009/0168030 A1
(43) Pub. Date: Jul. 2, 2009

(54) DISPLAY AND DESIGN METHOD THEREOF

(75) Inventors: Jung-Yao CHEN, Hsinchu (TW); Ching-Lung LAI, Hsinchu (TW); Tung-Hua CHOU, Hsinchu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: YOUNG OPTICS INC., Hsinchu (TW)

(21) Appl. No.: 12/128,656

(22) Filed: May 29, 2008

(30) Foreign Application Priority Data
Jan. 2, 2008 (TW) 97100036

(51) Int. Cl. G03B 21/28

(52) U.S. Cl. 353/99

(57) ABSTRACT

A display is provided including a light source, a light valve, a projection lens, a first planer reflector, a second planer reflector, a curved reflector and a projection plane. The light source is capable of emitting a light beam. The light valve is disposed on a light path of the light beam to transform the light beam into an image light beam. The projection lens is disposed on a light path of the image light beam. The first planer reflector reflects the image light beam from the projection lens. The second planer reflector reflects the image light beam from the first planer reflector. The curved reflector reflects the image light beam from the second planer reflector. The image light beam from the curved reflector is projected on the projection plane to form a projection image.

### BACKGROUND OF THE INVENTION

1. Field of the Invention

The invention relates to a design method for a display, and more particularly to a design method for reducing a thickness of a display.

2. Description of the Related Art

FIG. 1 shows a conventional display 1 disclosed in U.S. Pat. No. 6,824,274, which includes a micro mirror device 14, a refracting optical lens 58, a path-bending reflector 59, a curved mirror 60, a planer mirror 22 and a screen 18. In the related art, the path-bending reflector 59 is disposed between the refracting optical lens 58 and the curved mirror 60 so as to allow the refracting optical lens 58 and the curved mirror 60 to rotate on a horizontal plane. The horizontal plane is defined by the curved mirror 60 and an optic axis 61. Conventionally, the optic axis is only modified on the horizontal plane. Thus, design freedom of light path is limited, and the display is thicker.

### BRIEF SUMMARY OF THE INVENTION

A detailed description is given in the following embodiments with reference to the accompanying drawings.

A display is provided in accordance with an embodiment of the invention. The display includes a light source, a light valve, a projection lens, a first planer reflector, a second planer reflector, a curved reflector and a projection plane. The light source is capable of emitting a light beam. The light valve is disposed on a light path of the light beam to transform the light beam into an image light beam. The projection lens is disposed on a light path of the image light beam. The first planer reflector is disposed on the light path of the image light beam to reflect the image light beam from the projection lens. The second planer reflector is disposed on the light path of the image light beam to reflect the image light beam from the first planer reflector. The curved reflector is disposed on the light path of the image light beam to reflect the image light beam from the second planer reflector. The image light beam from the curved reflector is projected on the projection plane to form a projection image. The thickness of the display is modified by rotating the first planer reflector and the second planer reflector.

In an embodiment of the invention, the projection lens includes a first lens unit, a second lens unit and a third planer reflector, the third planer reflector is disposed between the first lens unit and the second lens unit, the image light beam passes through the first lens unit to the third planer reflector, the third planer reflector reflects the image light beam from the first lens unit toward the second lens unit, and the image light beam passes through the second lens unit to the first planer reflector. The thickness of the display is modified by rotating the first planer reflector, the second planer reflector and the third planer reflector.

Utilizing the display and the design method of the embodiments of the invention, design freedom of light path is increased, the display is thinner, and distortion of the image is decreased.

Other objectives, features and advantages of the present invention will be understood from further technology features disclosed by the embodiments of the present invention, shown and described simply by way of illustration of modes best suited to carry out the invention.

### BRIEF DESCRIPTION OF THE DRAWINGS

The invention can be more fully understood by reading the subsequent detailed description and examples with references made to the accompanying drawings, wherein:

FIG. 1 shows a conventional display disclosed in U.S. Pat. No. 6,824,274;

FIG. 2 shows a detailed structure of a display of a first embodiment of the invention;

FIGS. 3a to 3c show a complete structure of the display and a light path of an image light beam according to the first embodiment of the invention;

FIG. 4 shows a detailed structure of a display of a second embodiment of the invention; and

FIGS. 5a to 5c show a complete structure of the display and a light path of an image light beam according to the second embodiment of the invention.

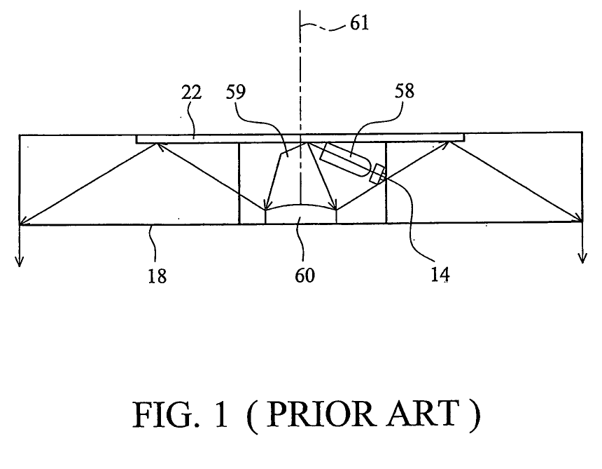

### DETAILED DESCRIPTION OF THE INVENTION

In the following detailed descriptions of the embodiments of the present invention, reference is made to the accompanying drawings which form a part hereof, and in which are shown by way of illustration the method in which the present invention may be practiced. In this regard, directional terminology, such as “top,” “bottom,” “front,” “back,” etc., is used with reference to the orientation of the Figure(s) being described. Meanwhile, the components of the present invention can be positioned in a number of different orientations. As such, the directional terminology is used for purposes of illustration and is by no means limiting. Additionally, the drawings are only schematic and the sizes of components may be exaggerated for clarity. It is also to be understood that other embodiments may be utilized and structural changes may be made without departing from the general scope of the present invention. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless otherwise limited, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect surface-to-surface/directional orientations, and “adjacent to” and variations thereof herein are used broadly and encompass directly and indirectly “adjacent to” orientations. Therefore, the description of “A” component is facing “B” component herein may encompass situations where “A” component directly faces “B” component or one or more additional components are between “A” component and “B” component. Also, the description of “A” component is adjacent to “B” component herein may encompass situations where “A” component is directly adjacent to “B” component or one or more additional components are between “A” component and “B” component. Accordingly, the drawings and descriptions will be regarded as illustrative in nature and not as restrictive.

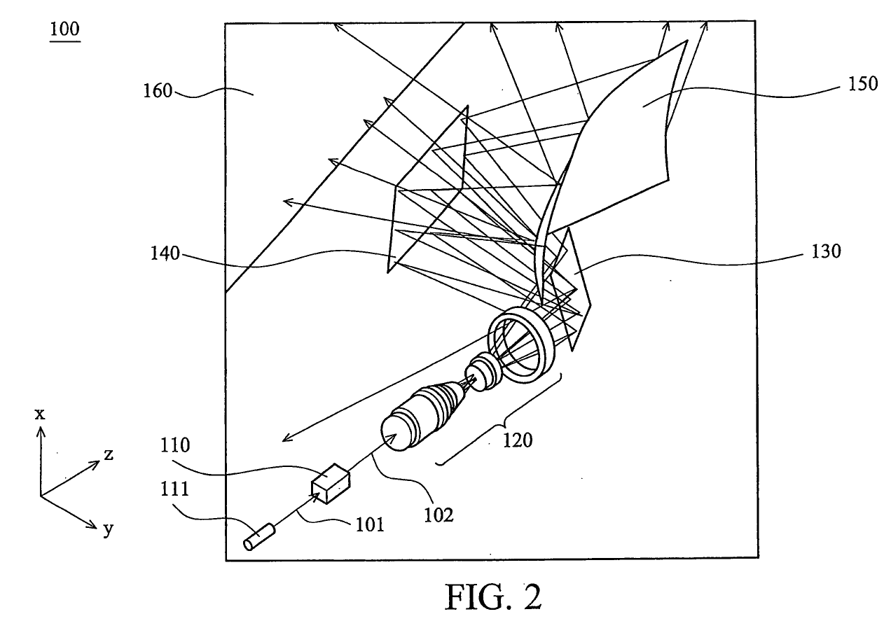

FIG. 2 shows a detailed structure of a display 100 of a first embodiment of the invention, which includes a light source 111, a light valve 110, a projection lens 120, a first planer reflector 130, a second planer reflector 140, a curved reflector 150 and a projection plane 160. The light source 111 is capable of emitting a light beam 101. The light valve 110 is disposed on a light path of the light beam 101 to transform the light beam 101 into an image light beam 102. The projection lens 120, the first planer reflector 130, the second planer reflector 140 and the curved reflector 150 are disposed on a light path of the image light beam 102 in sequence. The image light beam 102 passing through the projection lens 120 is reflected sequentially by the first planer reflector 130, the second planer reflector 140 and a curved reflector 150 to be projected to the projection plane 160.

In the first embodiment of the invention, the light valve 110 may be a digital micromirror device (DMD), the curved reflector 150 may be an aspherical reflector with a negative refractive power and the projection lens 120 is a telecentric lens. The projection lens 120 is capable of distorting the image light beam to generate a pincushion distortion. The curved reflector 150 distorts the image light beam 102 to generate a barrel distortion. The projection lens 120 incorporates the curved reflector 150 to generate an image with decreased distortion.

In the first embodiment, the projection lens 120 includes an aspherical lens. Note that the projection lens 120 may utilize lenses other than the telecentric lens.

In the first embodiment, the image light beam 102 travels from the light valve 110, and enters the projection lens 120 in a direction parallel to a first axis (z). A thickness of the display 100 is modified by rotating the first planer reflector 130 and the second planer reflector 140. The first planer reflector 130 is rotated along a second axis (y) and a third axis (x). The first axis (z), the second axis (y) and the third axis (x) are perpendicular to each other. The second planer reflector 140 is rotated along the first axis (z) and the third axis (x). The size of the display 100 on the second axis (y) and the third axis (x) is modified by rotating the first planer reflector 130; thus, height and thickness of the display 100 is modified. The size of the display 100 on the second axis (y) and the third axis (x) is also modified by rotating the second planer reflector 140; thus, height and thickness of the display 100 is modified.

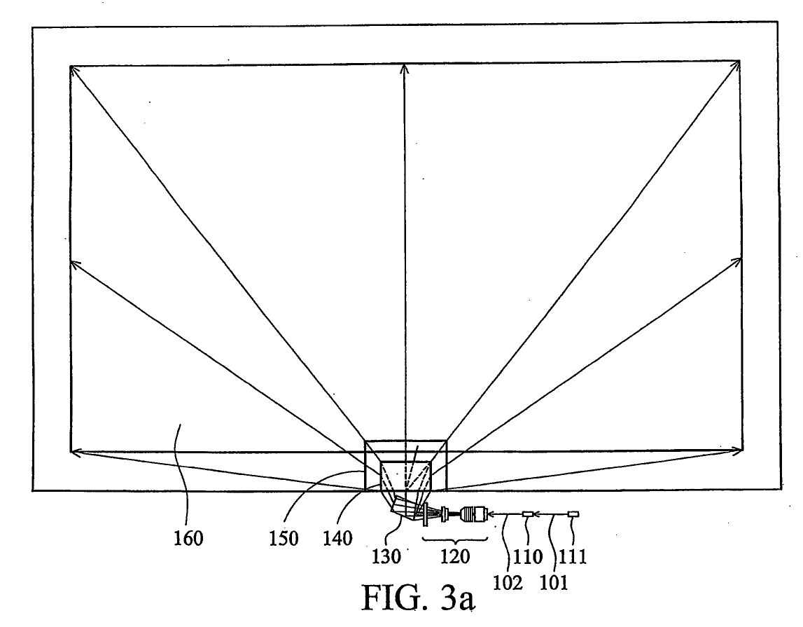

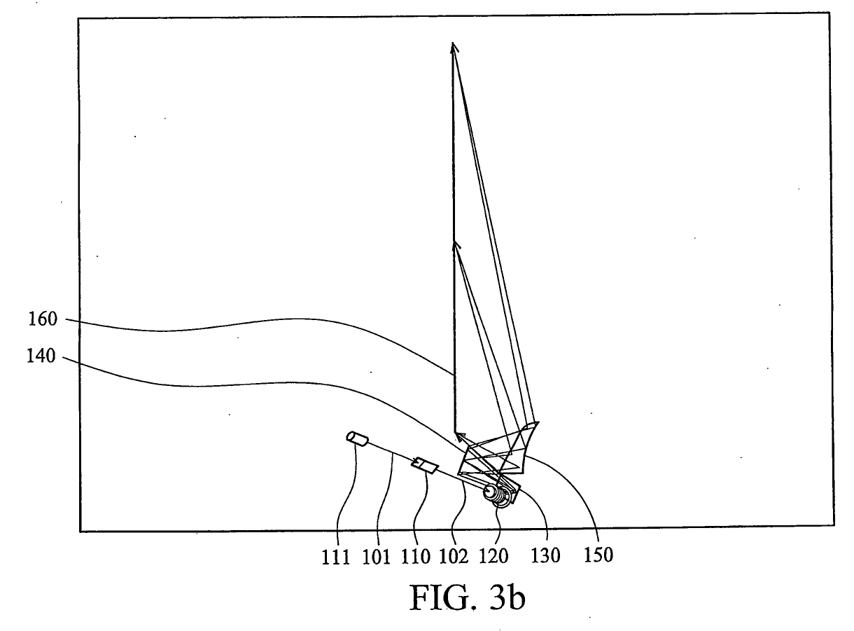

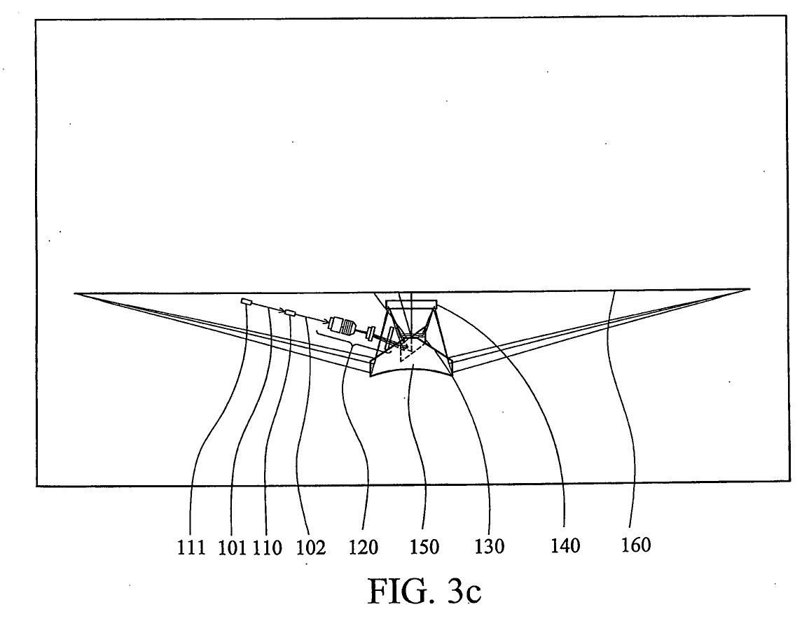

FIGS. 3a to 3c show a complete structure of the display 100 and the light path of the image light beam 102 according to the first embodiment of the invention. In the display 100 of the first embodiment of the invention, the thickness of the display 100 is modified by rotating the first planer reflector 130 and the second planer reflector 140. Therefore, design freedom of light path is increased, and the display 100 is thinner.

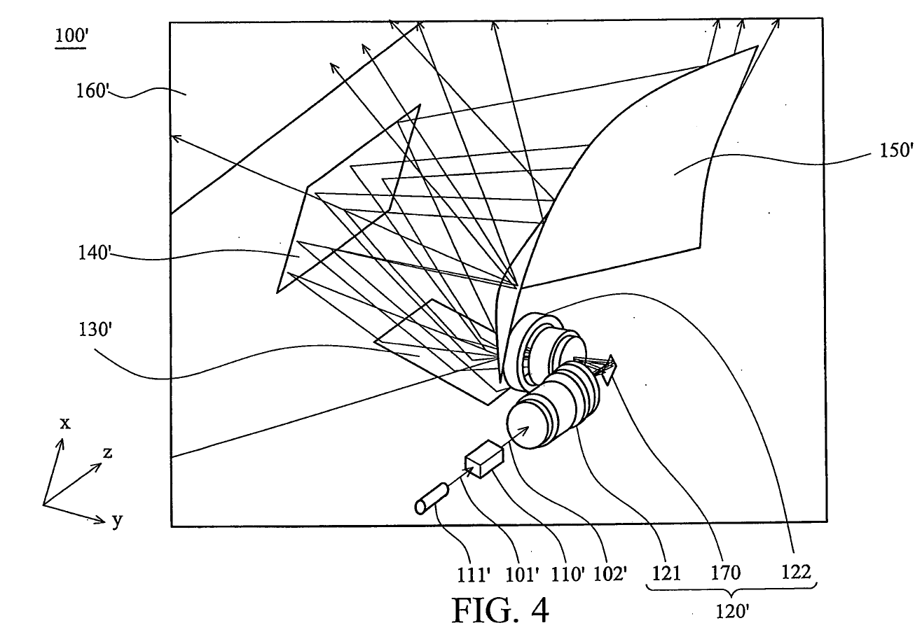

FIG. 4 shows a detailed structure of a display 100′ of a second embodiment of the invention, which includes a light source 111′, a light valve 110′, a projection lens 120′, a first planer reflector 130′, a second planer reflector 140′, a curved reflector 150′ and a projection plane 160′. The projection lens 120′ includes a first lens unit 121, a second lens unit 122 and a third planer reflector 170 disposed between the first lens unit 121 and the second lens unit 122. The light source 111 ′ is capable of emitting a light beam 101′. The light valve 110′ is disposed on a light path of the light beam 101′ to transform the light beam 101′ into an image light beam 102′. The first lens unit 121, the third planer reflector 170, the second lens unit 122, the first planer reflector 130′, the second planer reflector 140′ and the curved reflector 150′ are disposed on a light path of the image light beam 102′ in sequence. The image light beam 102′ passes through the first lens unit 121 to the third planer reflector 170, is reflected by the third planer reflector 170 to the second lens unit 122, passes through the second lens unit 122 to the first planer reflector 130′, and is reflected by the first planer reflector 130′, the second planer reflector 140′ and the curved reflector 150′ to the projection plane 160′ in sequence.

Similar to the first embodiment, the light valve 110′ may be a digital micromirror device (DMD). The curved reflector 150′ may be an aspherical reflector with a negative refractive power. The first lens unit 121 and the second lens unit 122 compose a telecentric lens. The first lens unit 121 and the second lens unit 122 are capable of distorting the image light beam to generate a pincushion distortion. The curved reflector 150′ distorts the image light beam 102′ to generate a barrel distortion. The first lens unit 121 and the second lens unit 122 incorporate the curved reflector 150′ to generate an image with decreased distortion.

In the second embodiment, the first lens unit 121 and the second lens unit 122 include an aspherical lens, and are arranged in an L-shape. The first lens unit 121 and the second lens unit 122 may utilize lenses other than the telecentric lens.

In the second embodiment, the image light beam 102′ travels from the light valve 110′ along a first axis (z), and passes through the first lens unit 121. A thickness of the display 100′ is modified by rotating the first planer reflector 130′, the second planer reflector 140′ and the third planer reflector 170. The third planer reflector 170 rotates along a third axis (x). The first axis (z) is perpendicular to the third axis (x). The second planer reflector 140′ rotates along the first axis (z). The first planer reflector 130′ also rotates along the first axis (z). In the second embodiment, the rotation of the first planer reflector 130′ relates to the rotation of the second planer reflector 140′. Specifically, the second planer reflector 140′ rotates in a first rotation angle with respect to a base plane (y-z plane), the first planer reflector 130′ rotates in a second rotation angle with respect to the base plane (y-z plane), a sum of an absolute value of the first rotation angle and an absolute value of the second rotation angle is 90 degrees. The first axis (z) and the second axis (y) are on the base plane. The first axis (z), the second axis (y) and the third axis (x) are perpendicular to each other. Size of the display 100′ on the second axis (y) is capable of being modified by rotating the third planer reflector 170 to modify the thickness of the display 100′. Size of the display 100′ on the second axis (y) and the third axis (x) is capable of being modified by rotating the second planer reflector 140′ to modify the thickness and height of the display 100′. Size of the display 100′ on the second axis (y) and the third axis (x) is capable of being modified by rotating the first planer reflector 130′ to modify the thickness and height of the display 100′.

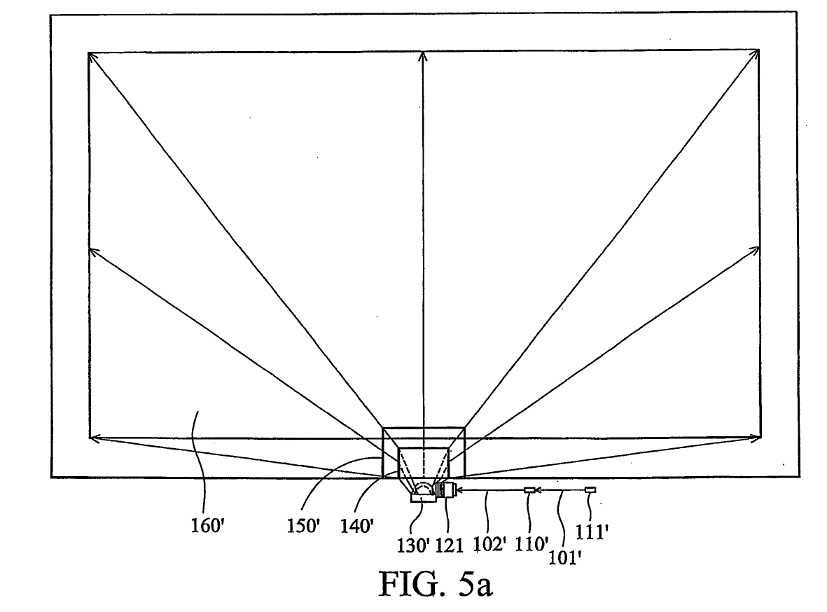

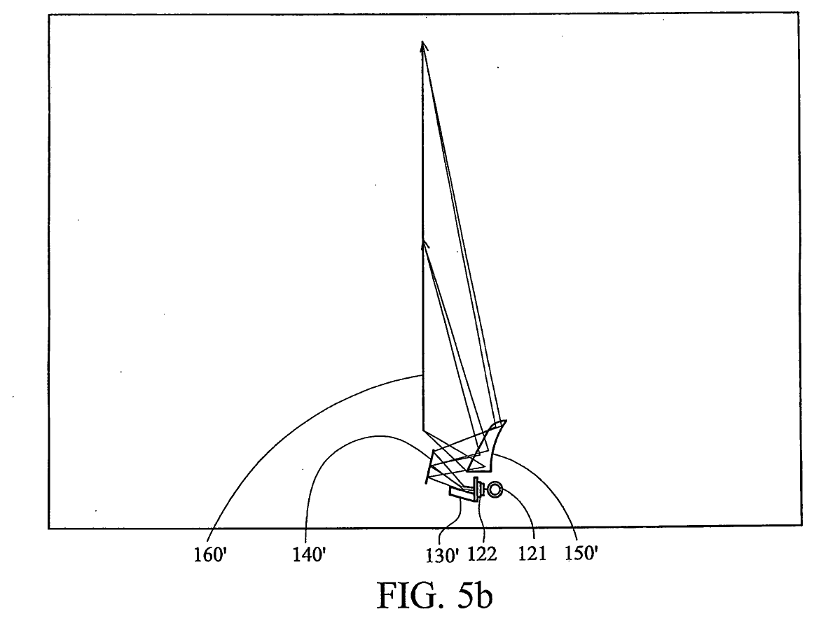

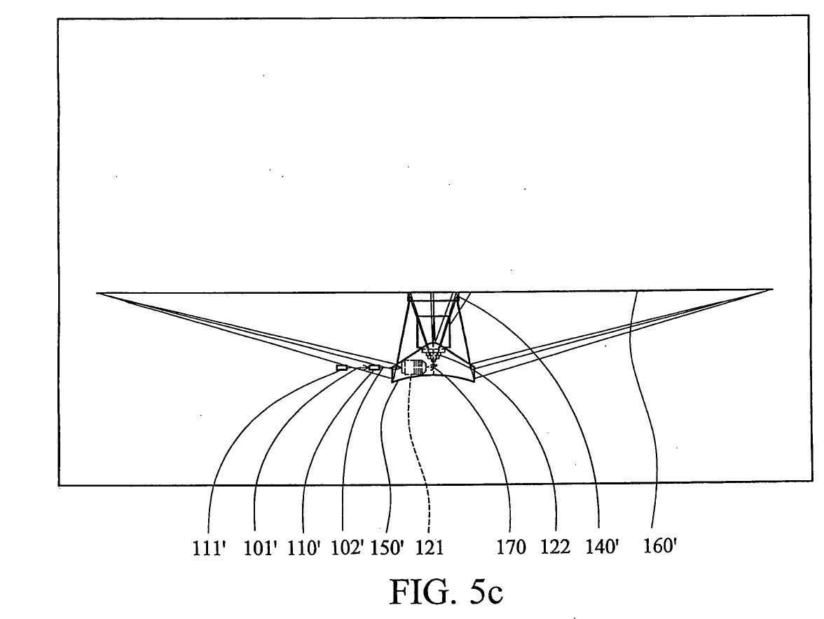

FIGS. 5a to 5c show a complete structure of the display 100′ and the light path of the image light beam 102′ according to the second embodiment of the invention. In the displays 100′ of the second embodiment of the invention, the thickness of the display is modified by rotating the first planer reflector 130′, the second planer reflector 140′ and the third planer reflector 170. Therefore, design freedom of light path is increased, and the display is thinner. Additionally, the first lens unit 121 and the second lens unit 122 are arranged in an L-shape, and interference during assembly between the first lens unit 121, the second lens unit 122 and the curved reflector 150′ is reduced.

The foregoing descriptions of the preferred embodiments of the present invention have been presented for purposes of illustration and description. It is not intended to be exhaustive or to limit the present invention to a precise form or to the exemplary embodiments disclosed. Accordingly, the foregoing description should be regarded as illustrative rather than restrictive. Obviously, a variety of modifications and variations will be apparent to those with ordinary skill in the art. Moreover, the embodiments are chosen and described in order to best explain the principles of the present invention and its best mode practical applications, to enable those with ordinary skill in the art to understand the present invention for implementation of various embodiments and modifications of the present invention, which conform to particular usages or contemplated implementations. It is intended that the scope of the present invention be defined by the claims appended hereto and their equivalents, whereby all terms are meant in their broadest reasonable sense unless otherwise indicated. Therefore, the term “the invention”, “the present invention” or the like does not necessarily limit the claim scope to a specific embodiment, and references to “preferred exemplary embodiments of the present invention”, do not imply a limitation on the present invention and no such limitation is to be inferred. The present invention is limited only by the general spirit and scope of the appended claims. The abstract of the present disclosure is provided to comply with the rules required for an abstract, which will allow a searcher to quickly ascertain the subject matter of the technical disclosure of any patent issued related to the present disclosure. It is submitted with the understanding that it will not be used to interpret or limit the scope or meaning of the claims. Meanwhile, any advantages and benefits described in the present disclosure for the present invention may not apply to all embodiments of the present invention. It should be appreciated that variations may be made to the embodiments described herein by those skilled in the art, without departing from the general scope of the present invention as defined by the following claims. Moreover, no element and component in the present disclosure is intended to be dedicated to the public, regardless of whether the element or component is explicitly recited in the following claims.

What is claimed is:

1. A display, comprising:
a light source, capable of emitting a light beam;
a light valve, disposed on a light path of the light beam to transform the light beam into an image light beam;
a projection lens, disposed on a light path of the image light beam;
a first planer reflector, disposed on the light path of the image light beam to reflect the image light beam from the projection lens;
a second planer reflector, disposed on the light path of the image light beam to reflect the image light beam from the first planer reflector;
a curved reflector, disposed on the light path of the image light beam to reflect the image light beam from the second planer reflector; and
a projection plane, wherein the image light beam from the curved reflector is projected on the projection plane to form a projection image.

2. The display as claimed in claim 1, wherein the curved reflector has a negative refractive power.

3. The display as claimed in claim 1, wherein the projection lens comprises a telecentric lens.

4. The display as claimed in claim 1, wherein the projection lens is capable of generating a pincushion distortion, and the curved reflector is capable of generating a barrel distortion.

5. The display as claimed in claim 1, wherein the projection lens comprises a first lens unit, a second lens unit and a third planer reflector, the third planer reflector is disposed between the first lens unit and the second lens unit, the image light beam passes through the first lens unit to the third planer reflector, the third planer reflector reflects the image light beam from the first lens toward the second lens unit, and the image light beam passes through the second lens unit to the first planer reflector.

6. The display as claimed in claim 5, wherein a rotation of the first planer reflector relates to a rotation of the second planer reflector.

7. The display as claimed in claim 5, wherein the first lens unit and the second lens unit comprise a telecentric lens.

8. The display as claimed in claim 5, wherein the first lens unit and the second lens unit are capable of generating a pincushion distortion, and the curved reflector is capable of generating a barrel distortion.

9. The display as claimed in claim 1, wherein the curved reflector comprises an aspherical reflector.

10. A display design method, comprising:
providing a display, and the display comprising a light source, a light valve, a projection lens, a first planer reflector, a second planer reflector, a curved reflector and a projection plane, wherein the light source is capable of emitting a light beam, the light beam is transmitted to the light valve to be transformed into an image light beam, and the image light beam passes the projection lens, the first planer reflector, the second planer reflector and the curved reflector in sequence so as to be projected to the projection plane; and
rotating the first planer reflector and the second planer reflector to modify a thickness of the display.

11. The display design method as claimed in claim 10, wherein the image light beam travels from the light valve parallel to a first axis and passes through the projection lens.

12. The display design method as claimed in claim 11, wherein the step of rotating the first planer reflector and the second planer reflector comprises rotating the first planer reflector along a second axis and a third axis, and the first axis, the second axis and the third axis are perpendicular to each other.

13. The display design method as claimed in claim 12, wherein the step of rotating the first planer reflector and the second planer reflector further comprises rotating the second planer reflector along the first axis and the third axis.

14. The display design method as claimed in claim 13, wherein a size of the display on the second axis and the third axis is capable of being modified by rotating the first planer reflector.

15. The display design method as claimed in claim 13, wherein a size of the display on the second axis and the third axis is capable of being modified by rotating the second planer reflector.

16. A display design method, comprising:
providing a display, and the display comprising a light source, a light valve, a projection lens, a first planer reflector, a second planer reflector, a curved reflector and a projection plane, wherein the projection lens comprises a first lens unit, a second lens unit and a third planer reflector disposed between the first and second lens units, the light source is capable of emitting a light beam, the light beam is transmitted to the light valve to be transformed into an image light beam, and the image light beam passes the first lens unit, the third planer reflector, the second lens unit, the first planer reflector, the second planer reflector and the curved reflector in sequence so as to be projected to the projection plane; and
rotating the first planer reflector, the second planer reflector and the third planer reflector to modify a thickness of the display.

17. The display design method as claimed in claim 16, wherein the image light beam travels from the light valve parallel to a first axis and passes through the first lens unit.

18. The display design method as claimed in claim 17, wherein the step of rotating the first planer reflector, the second planer reflector and the third planer reflector comprises rotating the third planer reflector along a third axis, and the first axis and the third axis are perpendicular to each other.

19. The display design method as claimed in claim 18, wherein the step of rotating the first planer reflector, the second planer reflector and the third planer reflector further comprises rotating the second planer reflector along the first axis.

20. The display design method as claimed in claim 19, wherein the step of rotating the first planer reflector, the second planer reflector and the third planer reflector further comprises rotating the first planer reflector along the first axis.

21. The display design method as claimed in claim 20, wherein the second planer reflector rotates in a first rotation angle with respect to a base plane, the first planer reflector rotates in a second rotation angle with respect the base plane, a sum of an absolute value of the first rotation angle and an absolute value of the second rotation angle is 90 degrees, the first axis and a second axis are on the base plane, and the first, second and third axes are perpendicular to each other.

22. The display design method as claimed in claim 20, wherein a size of the display on the second axis is capable of being modified by rotating the third planer reflector.

23. The display design method as claimed in claim 20, wherein a size of the display on the second axis and the third axis is capable of being modified by rotating the second planer reflector.

24. The display design method as claimed in claim 20, wherein a size of the display on the second axis and the third axis is capable of being modified by rotating the first planer reflector.
